(19) United States
(12) Patent Application Publication
(10) Pub. No.: US 2026/0277070 A1
(43) Pub. Date: Sep. 17, 2026

(54) RELAYED LOOP OPTICALLY AMPLIFIED DEFLECTION

(71) Applicant: Regents of the University of Minnesota, Minneapolis, MN (US)

(72) Inventors: Aaron Michael KERLIN, Minneapolis, MN (US); Harishankar JAYAKUMAR, Minneapolis, MN (US); Christopher WARKENTIN, Minneapolis, MN (US); Samuel STANEK, Minneapolis, MN (US); Deano FARINELLA, Minneapolis, MN (US)

(21) Appl. No.: 19/679,449

(22) Filed: May 15, 2026

Related U.S. Application Data
(63) Continuation of application No. PCT/US2025/033569, filed on Jun. 13, 2025.
(60) Provisional application No. 63/660,319, filed on Jun. 14, 2024.

(51) Int. Cl. G02F 1/29; G02B 21/06

(52) U.S. Cl. CPC G02F 1/29; G02B 21/06

(57) ABSTRACT

Optical systems and methods include and/or implement a light input configured to receive a light from a light source; an optical deflector configured to impart a deflection on the light; an optical redirector configured to relay the deflected light through the optical deflector a predetermined number of times in a loop to create a plurality of virtual deflectors and generate a multiply deflected light; and a light output configured to transmit the multiply deflected light to an external element.

### CROSS-REFERENCE TO RELATED APPLICATIONS

This application claims priority to and the benefit of U.S. Provisional Application No. 63/660,319, filed Jun. 14, 2024, the entire contents of which are herein incorporated by reference for all purposes.

### STATEMENT REGARDING FEDERALLY SPONSORED RESEARCH OR DEVELOPMENT

This invention was made with government support under NS128658 awarded by the National Institutes of Health. The government has certain rights in the invention.

### TECHNICAL FIELD

This disclosure relates to the field of microscopy. More particularly, this disclosure relates to optical systems and methods for two-photon microscopy with increased field-of-view.

### SUMMARY

A wide variety of modern sensing and fabrication technologies depend upon the sequential scanning of laser light across a region of interest. Examples include laser scanning microscopy (LSM), light detection and ranging (LiDAR), and photopolymerization-based 3D fabrication. The speed at which such technologies can scan light has a large impact on their utility and cost-effectiveness in many ways. First, processes that require addressing billions of points, such as fabricating a large part or imaging an entire labeled organ with LSM, can take hours to days to complete, monopolizing expensive equipment. Second, processes that require sensing at very high speeds, such as imaging dynamic processes in live biological specimens with LSM or estimating collision probability with automotive LiDAR, are forced to trade-off between spatial resolution and temporal resolution, limiting their effectiveness.

The speed of such sequential scanning techniques is usually limited by the speed at which an apparatus can deflect laser light to address each point in the region of interest. Fundamental inertial, thermal, and electrical limitations limit the speed at which one can control the deflection of light. For mechanically scanning mirrors, which are used in the majority of scanning devices, inertial limitations in particular dictate that scanner speed is inversely related to mirror size. Thus, reducing mirror size can increase scanning speed, but this comes at the cost of decreasing the optical resolution of the system. Solid-state deflectors, such as electro-optical and acousto-optical deflectors, also have similar trade-offs between the aperture of the deflector (i.e., optical resolution) and the rate at which the deflector can address different locations (i.e., scanning speed).

According to one aspect of the present disclosure, an optical deflection system is provided. The system comprises a light input configured to receive a light from a light source; an optical deflector configured to impart a deflection on the light; an optical redirector configured to relay the deflected light through the optical deflector a predetermined number of times to create a plurality of virtual deflectors and generate an angle multiplied deflected light; and a light output configured to transmit the angle multiplied deflected light to an external element.

### BRIEF DESCRIPTION OF THE DRAWINGS

FIG. 1 illustrates an example of the targeted imaging of a single neural volume.

FIG. 2A illustrates an example crystal in accordance with various aspects of the present disclosure.

FIG. 2B illustrates example optical characteristics according to various aspects of the present disclosure.

FIG. 2C illustrates an example deflector according to various aspects of the present disclosure.

FIG. 3A illustrates a conceptual example of optical techniques in accordance with a comparative example.

FIG. 3B illustrates a conceptual example of optical techniques in accordance with various aspects of the present disclosure.

FIG. 3C illustrates an example of looping in accordance with various aspects of the present disclosure.

FIG. 3D illustrates an example of looping in accordance with various aspects of the present disclosure.

FIG. 4A illustrates an example schematic of an example deflection system in accordance with various aspects of the present disclosure.

FIG. 4B illustrates a ray-tracing perspective view of the example of FIG. 4A.

FIG. 4C illustrates a perspective view of the example of FIG. 4A.

FIG. 4D illustrates a perspective view of the example of FIG. 4A.

FIG. 5A illustrates a loop-plane view of an example deflection system in accordance with various aspects of the present disclosure.

FIG. 5B illustrates a scan-plane view of an example deflection system in accordance with various aspects of the present disclosure.

FIG. 5C illustrates a loop-plane view of another example deflection system in accordance with various aspects of the present disclosure.

FIG. 5D illustrates a scan-plane view of another example deflection system in accordance with various aspects of the present disclosure.

FIG. 6A illustrates a perspective view of an example 1D deflection system accordance with various aspects of the present disclosure.

FIG. 6B illustrates a scan-plane view of an example 1D deflection system in accordance with various aspects of the present disclosure.

FIG. 6C illustrates a loop-plane view of an example 1D deflection system in accordance with various aspects of the present disclosure.

FIG. 7A illustrates a ray-tracing loop-plane view of an example 2D deflection system in accordance with various aspects of the present disclosure.

FIG. 7B illustrates a ray-tracing scan-plane view of an example 2D deflection system in accordance with various aspects of the present disclosure.

FIG. 7C illustrates a loop-plane view of an example 2D deflection system in accordance with the present disclosure.

FIG. 7D illustrates an example schematic of a 2D deflection system in accordance with the present disclosure.

FIG. 7E illustrates example results of a 2D deflection system in accordance with various aspects of the present disclosure.

FIG. 8 illustrates a graph of the effects of an example 2D deflection system in accordance with various aspects of the present disclosure.

FIG. 9 illustrates the functionality of systems and methods in accordance with the present disclosure.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts, and embodiments described herein may be implemented and practiced without these specific details.

Before any aspects of the invention are explained in detail, it is to be understood that the invention is not limited in its application to the details of construction and the arrangement of components set forth in the following description or illustrated in the following drawings. The invention is capable of other aspects and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

It is also to be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed or that the first element must precede the second element in some manner.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as, e.g., “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as, e.g., “either,” “one of,” “only one of,” or “exactly one of.”

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features dis-closed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

While the present disclosure is primarily described in the context of two-photon microscopy (2PM) for explanatory purposes, the systems and methods set forth herein are not limited solely to 2PM implementations and, in other examples, may be applied to a variety of different technical implementations. For example, the systems and methods set forth herein may be used for laser scanning microscopy, confocal microscopy, multiphoton microscopy techniques other than 2PM, other nonlinear microscopy techniques, ultrafast two-photon nanofabrication (e.g., for nanofabrication of electronics, microdevices, consumer devices, etc.), three-dimensional bioprinting, LiDAR, telecommunications, display projection devices, fiber-optic switches, or any other technological field in which there exists a need or desire to deflect light with an increased FOV and/or with a reduced step-settle time.

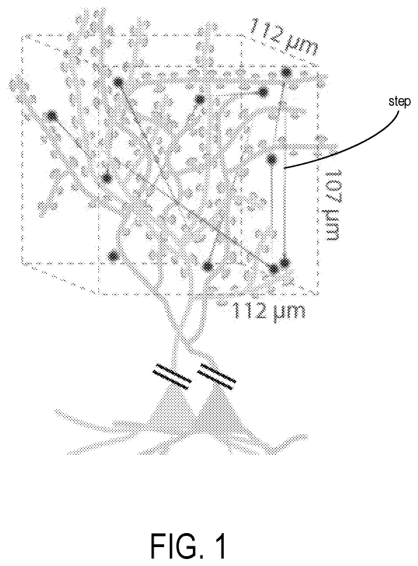

Single neurons are highly computationally complex systems. It has been deter-mined that there are on the order of 3000 inputs to one neuron across millimeters of dendrites. The inputs are integrated nonlinearly across multiple scales. The inputs interact with each other and the output of the neuron at millisecond timescales. While fluorescent sensors of synaptic communications have been developed that follow information flow with millisecond precision, comparative microscopy examples are not capable of imaging the thousands of inputs to one neuron with millisecond precision. FIG. 1 illustrates an example of the targeted imaging of a single neuron volume (112 μm×112 μm×107 μm) at more than 1000 synapses per millisecond. In FIG. 1, dots illustrate the imaging of an example microscopy system, with lines connecting the dots to illustrate the scanning motion steps. To spatially localize brain signals, there exists a need for sub-microsecond step-settle times (i.e., time between successive imaging operations, allowing for the optical system to settle).

Comparative examples of 2P microscopy for spatially localizing brain signals are limited by optical scanning elements, which deflect light in a controllable manner to scan across an imaging volume. None of the comparative examples of light deflection are sufficiently fast to spatially localize signals. For example, comparative examples utilizing galvanometric mirrors or resonant mirrors are mechanically limited, and have approximately 100 microsecond (small angle) step-settle times. These deflectors can only achieve 10 points per millisecond according to comparative examples. Comparative examples utilizing acousto-op-tic effects are limited by the transit time of acoustic waves in the crystal, and have an approximately 25 microsecond step-settle time with only 40 points per millisecond. Even EO deflection, which may achieve nanosecond response times in some implementations, have a limited FOV according to comparative examples.

The systems and methods of the present disclosure address these and other shortcomings of the comparative examples. In some example implementations, the present disclosure presents an electro-optical multiphoton microscope for imaging millisecond computation in vivo. The systems and methods of the present disclosure may provide, for example, a deflector for multiphoton imaging with a large (e.g., 10×) increase in resolvable spots, MHz random access 3D microscopy, and/or kHz activity recordings from on the order of 1000 targets.

The systems and methods set forth herein may be referred to as Relayed Loop Optically Amplified Deflection (ReLOAD) systems and methods. ReLOAD may be implemented with a variety of optical deflectors, including mechanical reflectors, acousto-optical deflectors, and/or EO deflectors. To achieve the detection of rapid cellular and subcellular events across many targets, a high-speed deflector device, such as one implementing EO deflection technology, may be used. An EO deflector can reach deflection frequencies 100× higher than comparative deflector devices. The deflection speed may depend on the ability of the driving electronics to generate changes in the electric field across the capacitance of the crystal. In particular examples, the systems and methods set forth herein utilize a deflector based on a potassium tantalate niobate (KTN) crystal, which exhibits a large change in index of refraction proportional to the square of an applied electric field (i.e., the electro-optical Kerr effect).

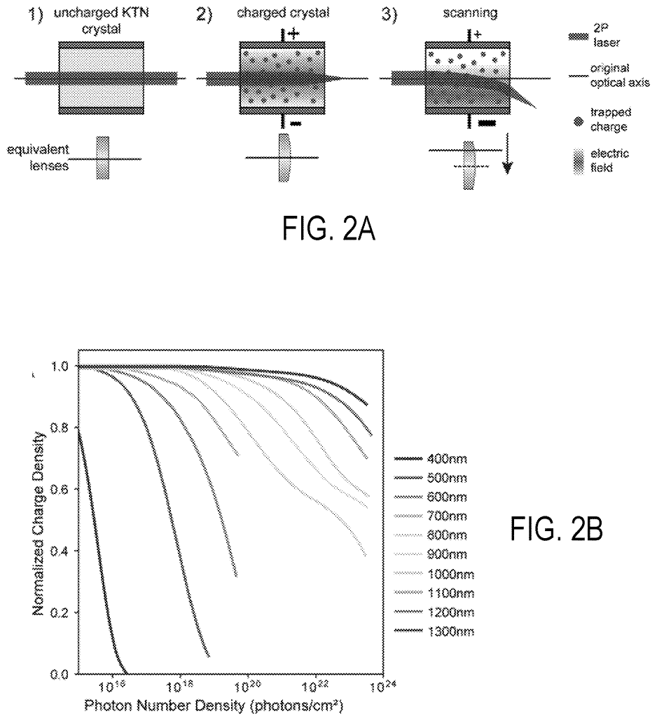

FIG. 2A illustrates an example of such an effect for a KTN based laser deflector. State (1) illustrates the deflector prior to the application of DC voltage and its equivalent lens. In state (1), the crystal contains no trapped charges and exhibits no lensing. State (2) illustrates the deflector when a DC voltage is applied and its equivalent lens. In this state, electrons are injected into the crystal and become trapped. These trapped charges change the index of refraction in the crystal via the Kerr effect, effectively forming a lens inside the crystal. State (3) illustrates the deflector when a voltage difference is applied to the charged crystal and its equivalent lens. In this state, the equivalent lens formed by the combination of applied voltage and trapped charges shifts off-axis, causing deflection. In the case where the voltage difference is a DC voltage, this deflection may be used for scanning.

KTN based deflector was analyzed for two-dimensional (2D) multiphoton imaging in vivo. No nonlinear intensity-dependent changes in deflector performance or evidence of self-focusing was observed at the highest tested pulse intensities (0.4 GW/cm²; 350 mW; 118 fs; 960 nm). This suggests that any nonlinear effects in KTN are small at 2P microscope pulse energies. By modifying commercial deflector control parameters, it was observed that a range of ~32 spots could be maintained up to a line rate of 560 kHz. This range declined as the line rate was driven beyond 560 kHz, which coincided with the appearance of a substantial thermal gradient across the crystal.

Illumination of charged KTN with visible light results in the rapid release of electrons from traps and discharge of the crystal. In an attempt to compensate for this discharge, comparative KTN deflectors have been designed to operate with large bias voltage to continually recharge the crystal during illumination. However, maintenance of this bias voltage suffers from undesirable effects, including a reduced maximum deflection angle due to vignetting at the exit aperture of the deflector, and an inability to use bipolar driving. FIG. 2B illustrates measured optical detrapping rates in KTN crystal across visible and near-IR wavelengths, from 430 nm to 1300 nm. Optical detrapping induced by near-IR light was many orders of magnitude slower than the detrapping induced by visible light. For example, illumination with 100 mW of 950 nm light only discharged the crystal by 40% after 7 hours. Because the crystal can be recharged in milliseconds, it may be operable without maintaining a bias in multiphoton applications.

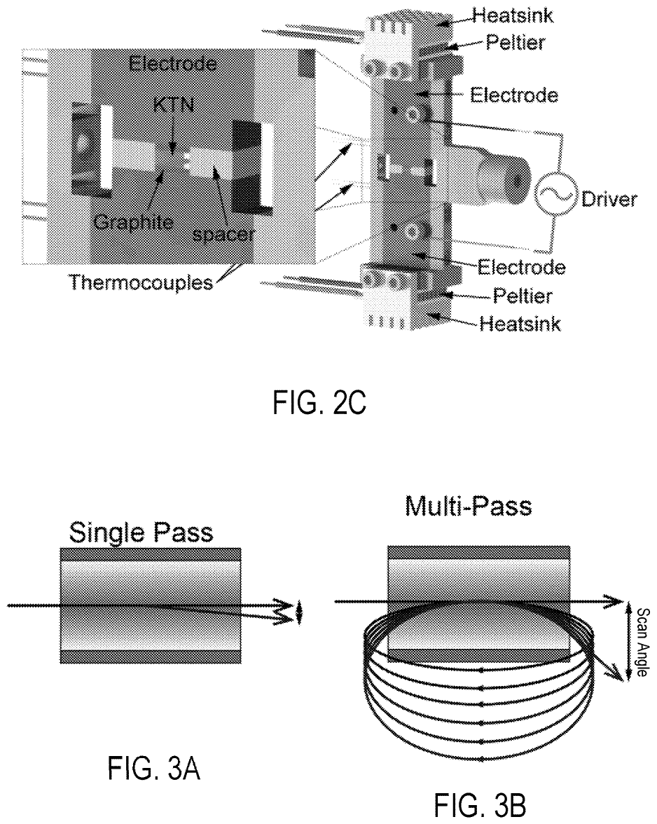

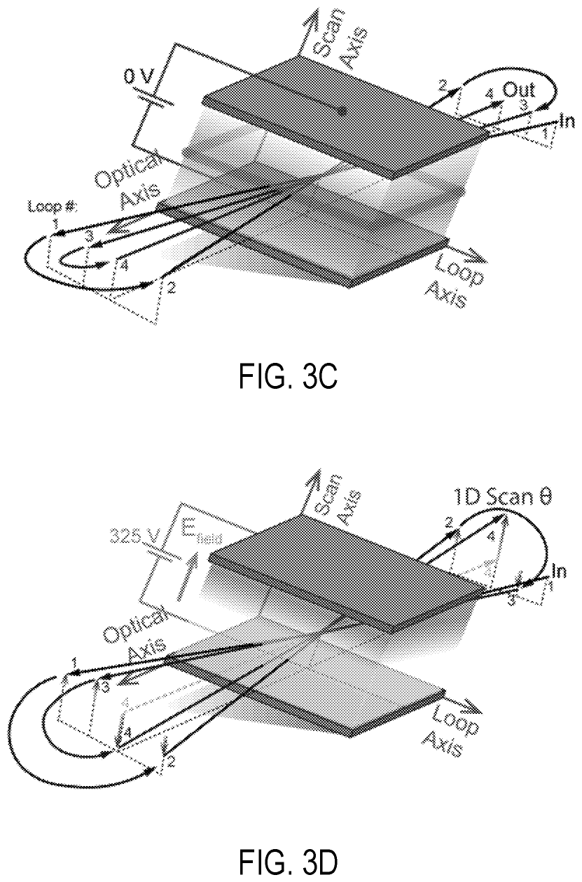

To leverage this persistently trapped charge, a custom deflector was designed that operates without bias, and was configured for bipolar drive. FIG. 2C illustrates an example CAD model of such a deflector, which includes the KTN crystal itself and copper electrodes attached to compressible graphite pads sandwiching the crystal (e.g., to decrease strain induced under drive conditions). The deflector is fitted with a thermal control system, which in the illustrated example includes two thermocouples, Peltier modules on the electrodes that use feedback from the thermocouples to maintain temperature uniformity across the crystal, and heatsinks. This thermal design may serve to prevent the formation of thermal gradients observed in the comparative deflector. As compared to the comparative deflector, the custom deflector of FIG. 3B can access 3× more resolvable spots per millimeter of interaction length.

The parameters of the deflector may be modified to achieve the desired balance between FOV and charging. In one example, a custom deflector was produced having a large aperture of 3.2 mm along the deflection axis. However, the thicker crystal used to achieve the larger aperture may be more difficult to charge. In one produced example, a maximum charge of 20 C/m³ was achieved, which is approximately 30% of the charge achieved for a smaller-aperture (1.2 mm) commercially available example. Additionally, the thicker crystals may be more likely to crack during high frequency (0.1-2.0 MHz) driving. However, it was found that an intermediate-aperture (2 mm) crystal could be charged to approximately 87% of the charge achieved for the smaller-aperture crystal while still increasing FOV. It was further found that the intermediate-aperture crystal could be operated without cracking at high frequency. Thus, in particular examples, the crystal aperture along the scan axis for a deflector according to the present disclosure may be 2 mm. However, as discussed below, even the smaller-aperture crystal may be used with the ReLOAD technique.

FIGS. 3A and 3B conceptually illustrate the operation of ReLOAD using a deflector (e.g., the deflector illustrated in FIG. 2C), as compared to a comparative example. FIG. 3A shows a comparative example having a single pass of light (oblique arrow) through a deflector. This single pass is analogous to comparative examples, and imparts a deflection to the light in a comparatively small deflection range relative to the optical axis (straight arrow).

Using the ReLOAD technique, the output of the deflector is relayed back onto itself in an optical loop, as shown in FIG. 3B. Each pass through the deflector provides a deflection in the manner shown in FIG. 3A, and thus the total deflection range is equivalent to the deflection range of a single pass multiplied by the number of loops. Relative to the optical axis (straight arrow), the overall deflection (oblique arrow) is much larger than in the comparative example. FIGS. 3C and 3D illustrate the ReLOAD behavior for 0V bias and 325V bias, respectively. To avoid interference between passes, the end mirror may impart a shift to the light beam in the plane orthogonal to the deflection plane with the optical beam travelling through the deflector on each pass. Entry of light into the loop and exit of the light from the loop may be encoded in the looping plane at or near the focal plane of the lenses, along or orthogonal to the deflection plane. The angular shift imparted by the end mirror spatially separates the light through the relay at the focal plane and angularly at the afocal conjugate plane, thereby making successive passes through the deflector. The amplification exit may be controlled by the magnitude of the fixed shift (e.g., in the height direction) per loop through the deflector. Any number (N) of loops may be implemented, corresponding to 2N virtual deflectors for transmissive deflectors (or N virtual deflectors for reflective deflectors), where N may be limited only by the design parameters of the optical components. In some examples, N may be up to 14 or higher. The total deflection range of the system is equivalent to the deflection range of a single pass multiplied by the number of virtual deflectors.

While the examples described above show a transmissive (e.g., KTN based electro-optical crystal) deflector, the ReLOAD technique is also usable with a reflective (e.g., mirror galvanometer, resonant scanner, MEMs scanner, etc.) deflector. In this regard, the particular type of deflector may be selected based on the operating parameters of the optical system and/or on the available components. For example, some mechanical scanning mirrors have speed limitations due to the mass of the mirror, but larger deflection range. On the other hand, EO deflectors are faster but have a limited deflection range. The ReLOAD technique effectively converts one deflector into many virtual deflectors and, thus, overcomes the limitations in either deflector type. In some examples, ReLOAD-based deflectors may be further miniaturized, for example by using metamaterial-based lenses to implement the relay on a smaller scale with more robust optics.

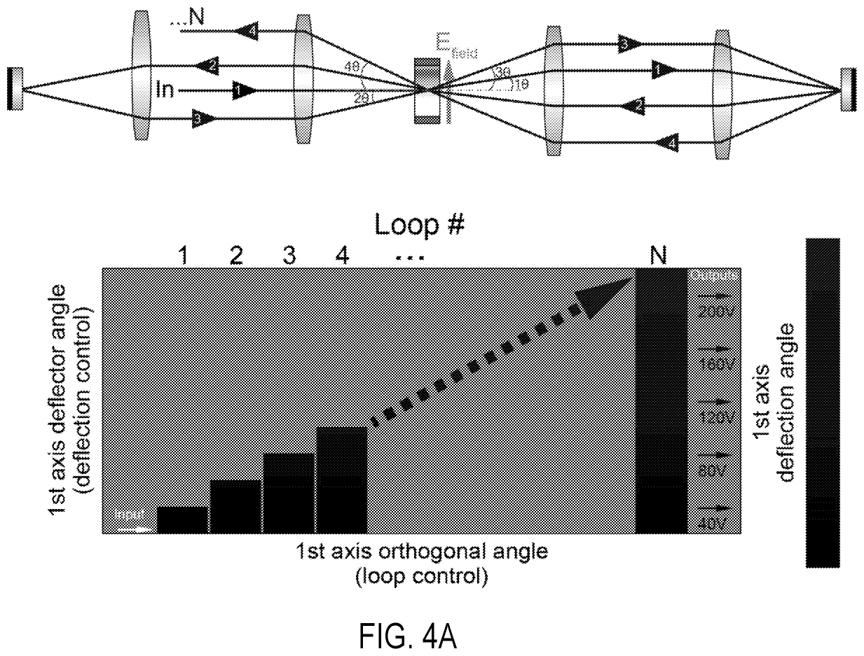

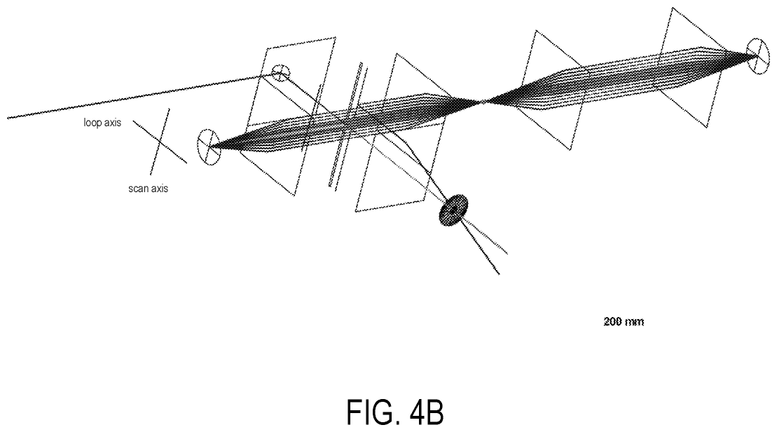

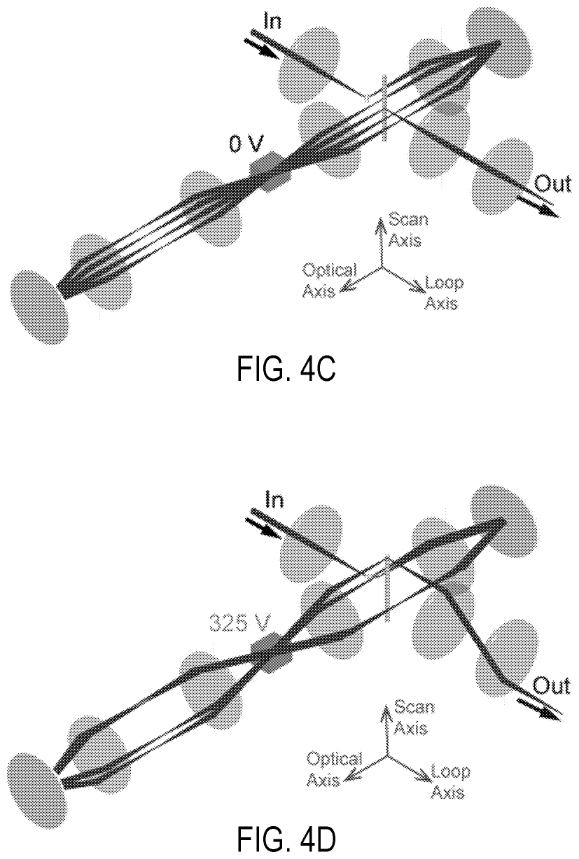

FIG. 4A illustrates a schematic of an example implementation of the ReLOAD technique using a deflection system that implements two or more loops (corresponding to four or more deflections) through a transmissive optical deflector. Light passes through the optical deflector, and is reflected back through the optical deflector a number of times before exiting the deflection system. Each pass through the optical deflector imparts a deflection by an angle of θ, such that the light has been deflected by an overall angle of 4θ for the four deflections that are explicitly shown. The graph shows that, as the number of loops increases, the overall deflection angle increases. FIGS. 4B-4C illustrate a perspective view of the example implementation, in which FIG. 4B shows a ray tracing diagram, FIG. 4C shows a perspective schematic corresponding to the driving shown in FIG. 3C, and FIG. 4D shows a perspective schematic corresponding to the driving shown in FIG. 3D.

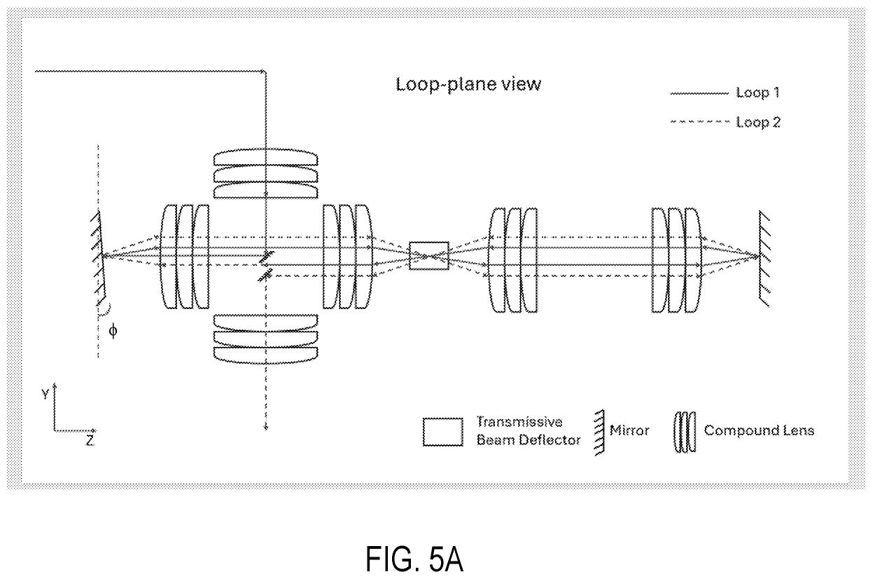

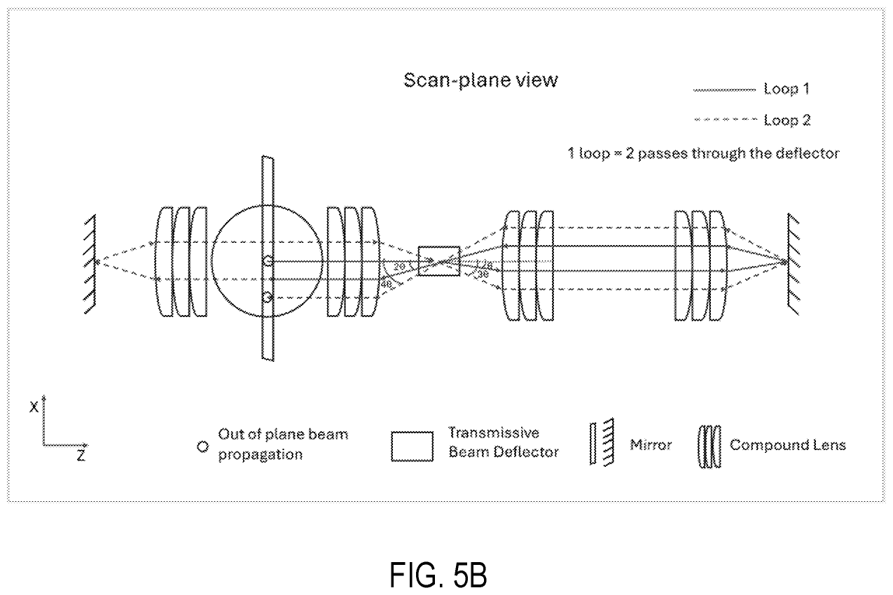

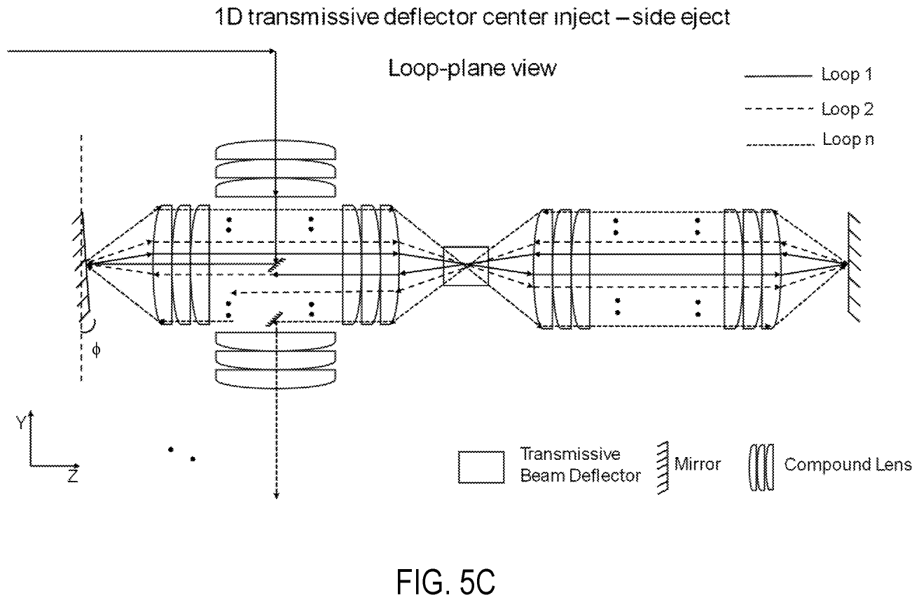

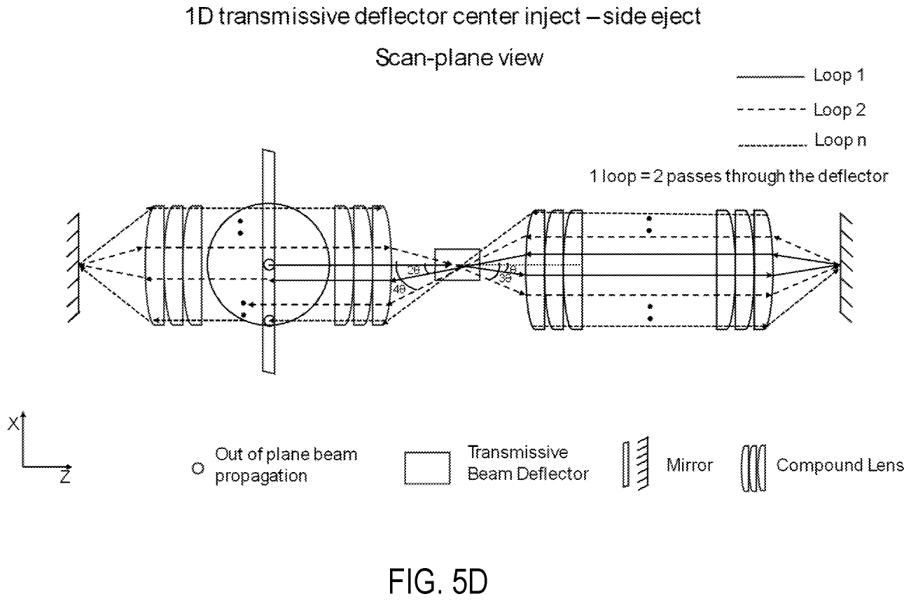

FIGS. 5A and 5B illustrate an example implementation of the deflection system of FIG. 4A in a loop-plane view and a scan-plane view, respectively. The example deflection system includes a plurality of compound lenses to shape and focus light passing therethrough, a transmissive beam deflector which deflects the light a plurality of times, and an optical redirector (as illustrated, two mirrors) to redirect (in the illustrated example, reflect) the light back and forth through the deflector. The optical redirector may include one or more chirped mirrors to compensate for group delay dispersion. As illustrated in FIG. 5A, one of the mirrors may be angled in the loop plane by an angle, φ, to shift the light to subsequent loops through the system. The system also includes an entry mirror to receive input light from a light source (e.g., a continuous or pulsed light source) and direct the input light toward the deflector on its initial path through the system, and an exit mirror to direct light toward any downstream optical elements after it has been deflected a number of times. The input light received may be a circular or elliptical beam and the input mirror may be positioned so as to include at least a portion of a center and/or an edge of focal plane of the deflection system. The number of loops can be modified either by repositioning the exit mirror or by changing the mirror angle φ.

While the discussion above is provided to illustrate an optical deflector with two loops, in other examples a larger number of loops may be present. as noted above with regard to FIGS. 3C and 3D, any number N loops may be present. In such examples, light sent by the entry mirror is redirected through the deflector a number of times before it is caught by the exit mirror and directed to downstream optical components. FIG. 5C shows a loop-plane view and FIG. 5D shows a scan-plane view of another example optical deflector which generally implements N loops.

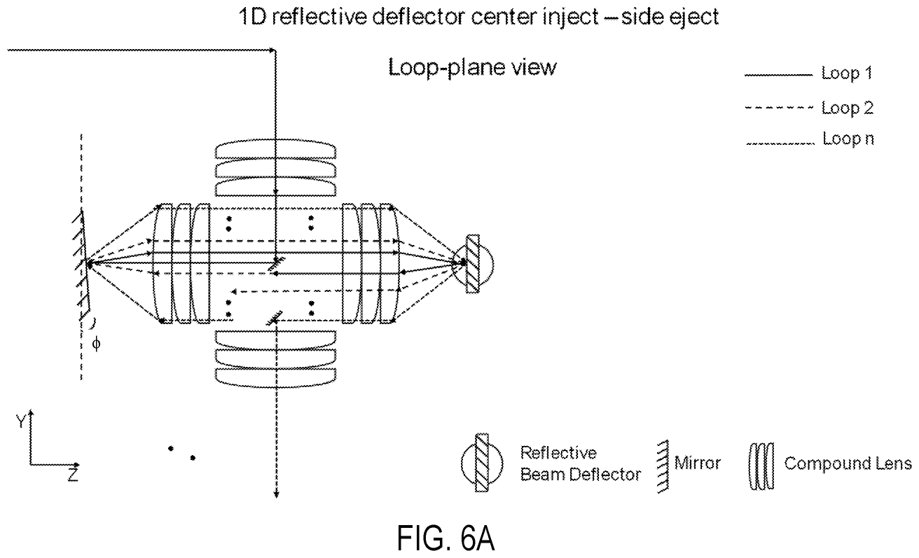

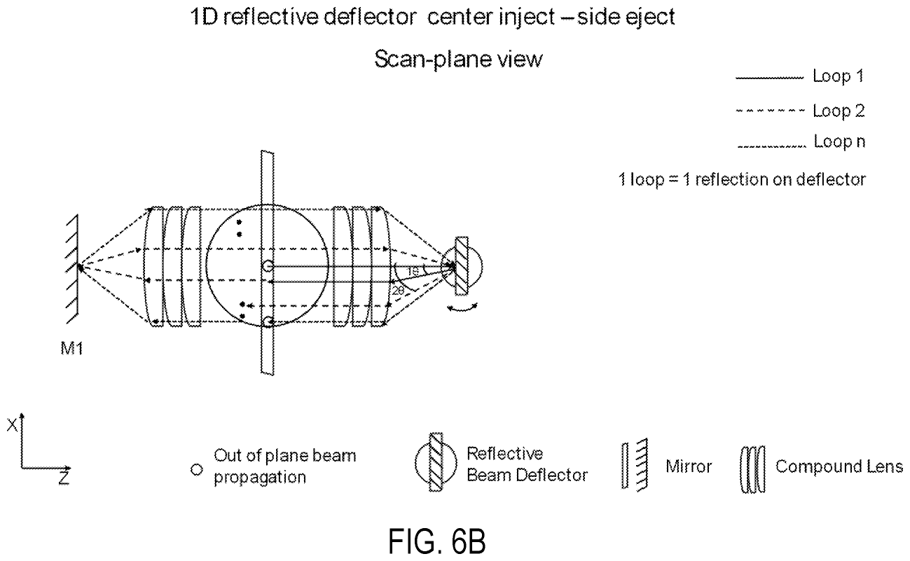

Moreover, note that in the above examples light passes through the optical deflector in both directions (i.e., twice per loop), and thus the “two-loop” deflection system includes four deflections. In other examples, light may pass through the optical deflector in only a single direction (i.e., once per loop), and thus a “two-loop” deflection system would include two deflections. Additionally, if a reflective deflector is used instead of the transmissive deflector, each loop through the deflection system may include only one deflection (i.e., one re-flection on the deflector). FIG. 6A and B illustrate a loop-plane view and scan-plane view, respectively, of such an implementation. In any implementation, however, any number of loops and any number of deflections may be implemented, limited only by the tolerances and performance parameters of the individual optical components. The deflection systems described above may be implemented in a custom assembly, or by arranging available optical components. Moreover, while the above examples show a system for imparting deflection in one direction (“1-D ReLOAD”), higher-dimensional systems are within the scope of the present disclosure.

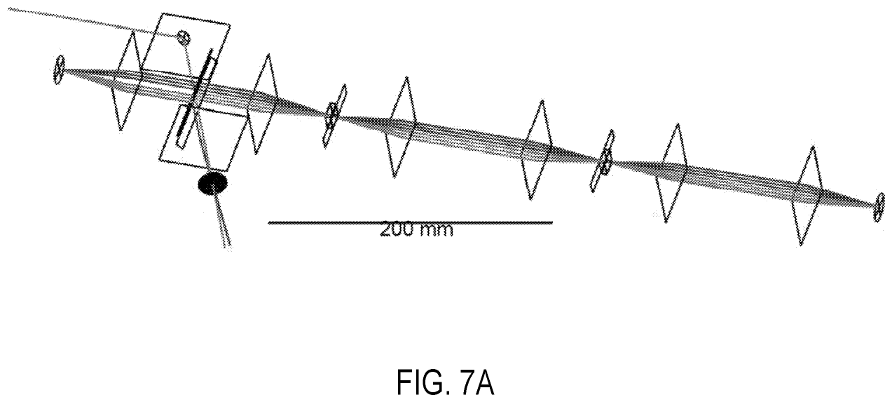

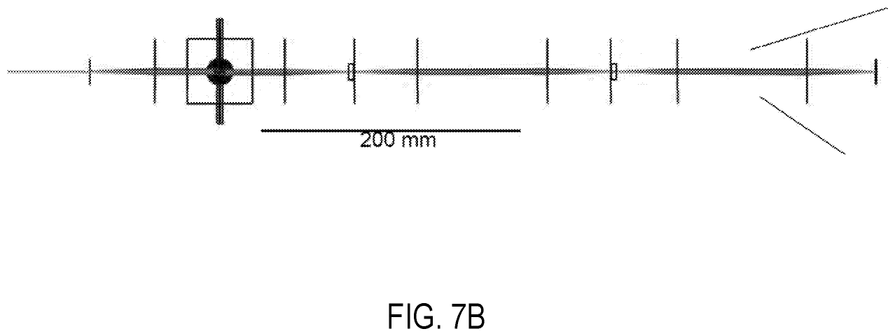

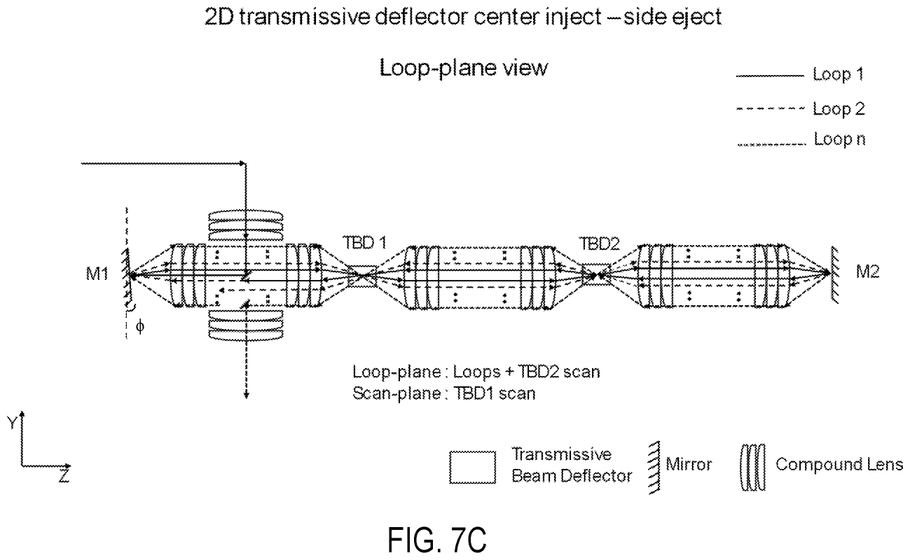

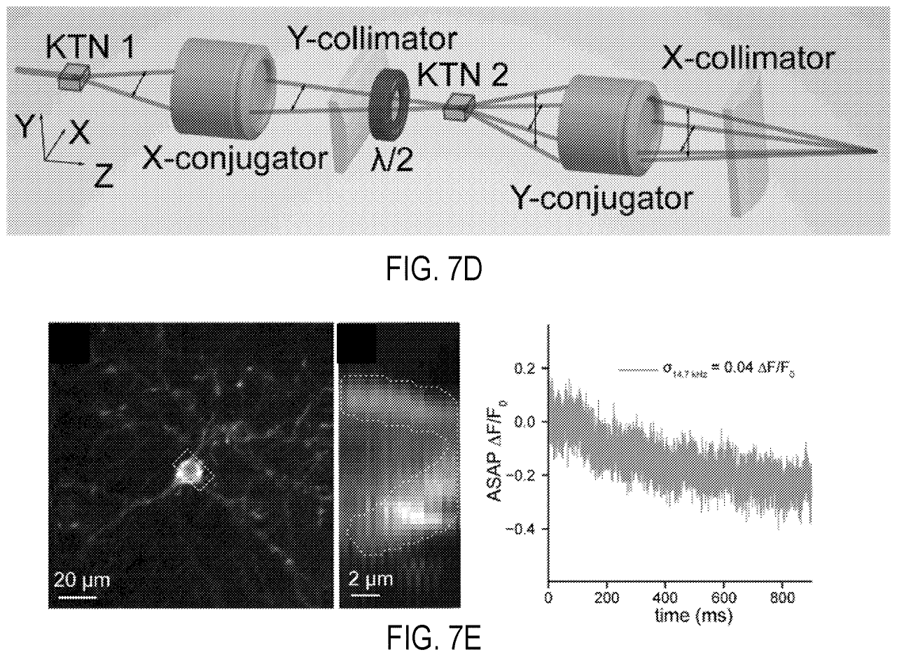

FIGS. 7A-7E illustrate an example system for imparting deflection in two directions (“2-D ReLOAD”). FIGS. 7A and 7D show a perspective view, whereas FIGS. 7B and 7C show scan-plane and loop-plane views, respectively. In FIG. 7D, “λ/2” refers to a half-wave plate. The two-dimensional deflector system includes two deflectors which impart deflections in orthogonal directions. On each pass through the system, light passes through each deflector in turn and is thus deflected in both directions a number of times. The system illustrated in FIGS. 7A-7D represents a fully electro-optical 2P microscope capable of imaging a 13 μm×13 μm FOV at up to 14.7 kHz frame rate (560 kHz line rate) with ~0.5 μm lateral resolution. The system was used to demonstrate in vivo imaging of neurons expressing ASAP3 at high temporal resolution. FIG. 7E shows, from left to right, a two-photon (2P) image of layer 2/3 pyramidal neuron expressing ASAP3 collected using galvanometers; 2D KTN-EOD scanning images (mean of 1000 frames at 14.7 kHz) of the regions marked by the dashed box in the left image; and single trial ASAP bleaching ΔF/Fₒ for regions indicated with the dotted lines in the central image with a SNR of σ.

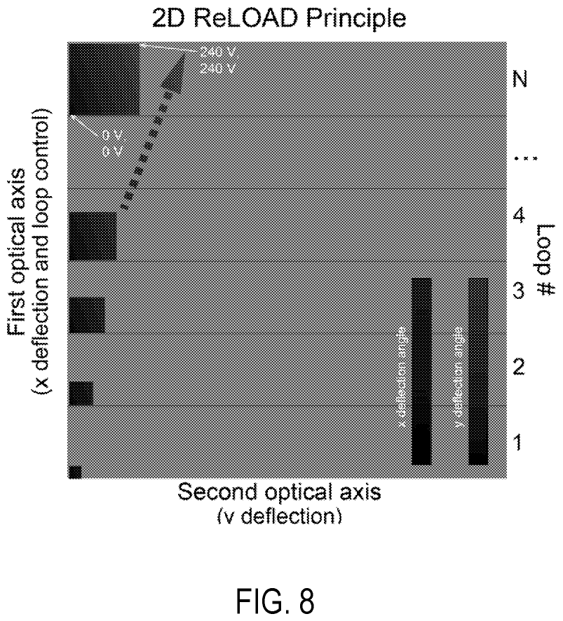

FIG. 8 illustrates the effects of 2D ReLOAD systems in accordance with the present disclosure. For each loop, a square is presented which shows the deflection behavior from the undeflected point in which no deflection is imparted (e.g., 0V applied to an EO deflector in both directions) to the maximally-deflected point in which the maximum achievable deflection is imparted (e.g., 240 applied to an EO deflector in both directions). As the number of loops increases, the deflection range along both the first and second (x and y) optical axis increases. This is evident from the increasing size of the squares as the number of loops increases.

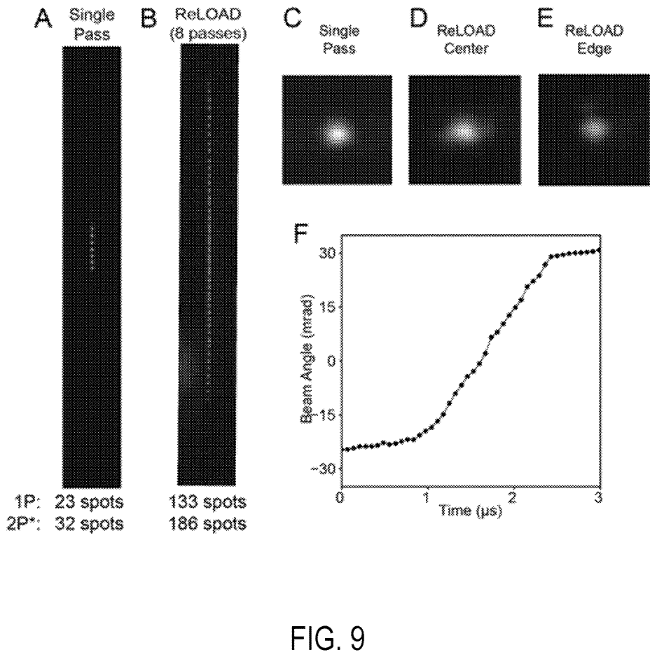

The effectiveness of the ReLOAD techniques set forth herein has been experimentally demonstrated. One example implementation of the present disclosure was tested with a 1.2 mm×3 mm×4 mm KTN crystal mounted in the deflector system shown in FIG. 2C. Focusing infrared light from a triggerable laser (970 nm; 50 ps pulses; EPL-980, Edinburgh Instruments) was injected into the module by a small prism reflector (86-261, Edmund Optics) at the edge of the focal plane of one relay. Inside the loop, light was relayed by 4 scan lenses (LSM 03-BB, Thorlabs; 99.8% near-IR transmission) and reflected by two dielectric end mirrors (BB05-E03, Thorlabs). A concave cylindrical lens (LK1982L1-B, Thorlabs) near the crystal compensated for the focusing effect of charged KTN. One end mirror was tilted along the axis orthogonal to the scanning axis such that after 4 loops (8 passes through the crystal) light hit a custom-cut eject mirror (1.2 mm×14 mm) mounted in the center of the relay. Imaging of the small fraction of light that transmitted through one of the end mirrors indicated that scan angle grew linearly with loop number. The results are illustrated in FIG. 9.

As shown in FIG. 9, ReLOAD-based deflection systems were compared to a single-pass deflection system. In single-photon imaging (tested by performing stroboscopic imaging of light deflected by the crystal outside of the ReLOAD loop, during 100 kHz scanning), the single-pass deflection system was only capable of resolving 23 spots with 650 Vₚₚ drive. Output from the same crystal placed within the ReLOAD module generated 133 resolvable spots (equivalent to 186 two-photon spots), corresponding to a gain of 5.8×. These results may further be improved by compensating for aberrations and losses created by vignetting on the crystal aperture. For example, OCT scan lenses with improved telecentricity may mitigate these effects. Overall transmission of 4 loops through the module (8 passes) was 11%. Most losses occurred at the crystal faces, where a low-fidelity magnesium fluoride antireflective coating was applied. It should be noted that, in some examples, a high reflective coating may instead be applied. FIG. 9 also shows the step-settle time of deflection, which was 1.4 μs, reflecting the bandwidth limit of the amplifiers used (two bridge 2100 HF, Advanced Energy) for driving a 2 nF load. Taken together, FIG. 9 shows that a 1D ReLOAD deflector is capable of ~1 μs random-access across 186 resolvable 2P spots. With a larger crystal aperture, higher quality scan lenses, and improved AR coatings compared to the tested example, the ReLOAD module could address greater than 300 2P resolvable spots.

Thus, in a first general aspect, the ReLOAD technique may include optically conjugating a variable deflector onto itself in a loop. Light is cycled through this loop, and each cycle increases the total number of optically resolvable points that the deflector can address. Implementations may include any one or more of the following: 4f optical systems, parabolic and/or refractive optical systems, transmissive and/or reflective optical systems, and mechanical and/or electro-optical systems.

In another general aspect, the ReLOAD technique may include the partitioning of optical space within an optical relay into a first subspace that encodes a variable deflection and a second orthogonal subspace that encodes the number of loops that the light has traveled. Light may be deflected by additional fixed or variable deflectors on each loop that encode within the orthogonal subspace the number of loops that the light has traveled. The entry of light into a loop, the number of cycles light travels within a loop, and the exit from a loop may be controlled by injecting light into points in an orthogonal subspace or retrieving light from points in an orthogonal subspace. Implementations may include any one or more of the following: encoding in the looping plane, partitioning a single axis, and any other partition of the full two-dimensional space. Implementations may further include sending light forward through the loop (i.e., collected from one point and sent to multiple points) and/or backwards through the loop (i.e., collected from multiple points and sent to one point).

In another general aspect, the ReLOAD technique may include injecting and ejecting light with optics placed at or near the focal plane of an optical relay loop. This technique may also include creating inject and eject optics with spatial dimensions and positions within the focal plane that match the injection deflection subspace and the ejection deflection subspace, respectively. This method of light injection and ejection increases the number of loops through which light can travel in a finite optical relay space. Implementations may include any one or more of the following: inside-out systems, outside-in systems, mirrors, prisms, minimally occluding supports, and the like.

In another general aspect, the ReLOAD technique includes optically conjugating multiple orthogonal deflectors and partitioning optical space within an optical relay into orthogonal subspaces that encode variable deflection along multiple dimensions and an orthogonal subspace that encodes the number of loops that light has traveled. Implementations may include one or more of the following: 2D ReLOAD partitioning, sequential loops, combined loops, and various other multi-axis configurations, such as those described above.

As described, the ReLOAD techniques implement relaying a deflector onto itself in a loop to create many virtual deflectors. In some aspects, exit from the loop can be encoded in one or more orthogonal spatial dimensions, one or more orthogonal temporal dimensions, or combinations thereof. Optical systems that implement the ReLOAD techniques described herein can implement optical geometry that fits multiple loops within the confines of practical relay acceptance angles for one-dimensional deflection. Additionally or alternatively, the optical geometry can fit multiple loops within the confines of practical relay acceptance angles for two-dimensional deflection. As described above, the optical geometry can enable reflective deflection and/or transmissive deflection. Accordingly, the ReLOAD techniques can be optimally combined with reflective devices and/or transmissive devices. The ReLOAD systems may be implemented using electro-optical deflectors as described above, or other deflectors including resonant scanning mirrors.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

1. An optical deflection system, comprising:
a light input configured to receive a light from a light source;
an optical deflector configured to impart a deflection on the light;
an optical redirector configured to relay the deflected light through the optical deflector a predetermined number of times in a loop to create a plurality of virtual deflectors and generate a multiply deflected light; and
a light output configured to transmit the multiply deflected light to an external element.

2. The optical deflection system of claim 1, wherein the optical deflector includes a first beam deflector configured to impart a deflection on the light along a first axis, and a second beam deflector configured to impart a deflection on the light along a second axis orthogonal to the first axis.

3. The optical deflection system of claim 1, wherein the light source is selectively configured to send light through the optical deflection system in a first direction or in a second direction opposite the first direction, combining light from multiple sources.

4. The optical deflection system of claim 1, further comprising an exit optical element configured to encode an exit from the loop in orthogonal spatial or temporal dimensions.

5. The optical deflection system of claim 4, wherein the exit optical element is configured to section a single plane within the optical deflection system.

6. The optical deflection system of claim 1, wherein the optical deflector is a reflective deflector.

7. The optical deflection system of claim 6, wherein the reflective deflector includes at least one of a mirror galvanometer, a resonant scanner, or a MEMS scanner.

8. The optical deflection system of claim 1, wherein the optical deflector is a transmissive deflector.

9. The optical deflection system of claim 8, further comprising an optical lens arrangement to place a conjugate plane of an afocal optical system at the deflector.

10. The optical deflection system of claim 8, wherein the transmissive deflector includes an electro-optical crystal.

11. The optical deflection system of claim 10, wherein the electro-optical crystal includes a potassium tantalate niobate (KTN) crystal.

12. The optical deflection system of claim 10, wherein the transmissive deflector includes an antireflective coating or a high reflective coating on at least one face of the electro-optical crystal.

13. The optical deflection system of claim 10, further comprising a thermal control system configured to maintain a temperature of the electro-optical crystal.

14. The optical deflection system of claim 13, wherein the thermal control system includes a temperature sensor and a Peltier module operatively connected to the temperature sensor.

15. The optical deflection system of claim 10, further comprising first and second compressible pads on opposite sides of the electro-optical crystal.

16. The optical deflection system of claim 1, wherein the light input is circular or elliptical.

17. The optical deflection system of claim 1, wherein the light input includes at least one of center or an edge of a looping plane orthogonal to an optical axis of the optical deflection system.

18. The optical deflection system of claim 1, wherein the light source is continuous or pulsed.

19. The optical deflection system of claim 1, wherein the optical redirector includes a chirped mirror configured to compensate for group delay dispersion.

20. A microscope comprising the optical deflection system of claim 1.
